(19) United States
(12) Patent Application Publication
(10) Pub. No.: US 2023/0031738 A1
(43) Pub. Date: Feb. 2, 2023

(54) TAXPAYER INDUSTRY CLASSIFICATION METHOD BASED ON LABEL-NOISE LEARNING

(71) Applicant: XI'AN JIAOTONG UNIVERSITY, Xi'an (CN)

(72) Inventors: Qinghua ZHENG, Xi'an (CN); Bo DONG, Xi'an (CN); Jianfei RUAN, Xi'an (CN); Rui ZHAO, Xi'an (CN); Bin SHI, Xi'an (CN)

(21) Appl. No.: 17/956,879

(22) Filed: Sep. 30, 2022

Related U.S. Application Data
(63) Continuation of application No. PCT/CN2021/079378, filed on Mar. 5, 2021.

(30) Foreign Application Priority Data
Mar. 5, 2021 (CN) 202110201214.5

(51) Int. Cl. G06Q 40/00; G06F 40/129

(52) U.S. Cl. CPC G06Q 40/10; G06F 40/129

(57) ABSTRACT

Disclosed is a taxpayer industry classification method based on label-noise learning, which comprises the following steps: extracting text information to be mined from taxpayer industry information for text embedding, and performing feature processing on the embedded information; extracting, non-text information from the taxpayer industry information for encoding; constructing a BERT-CNN deep network structure, a number of neurons and the dimensionality of input and output in each layer and the number of target categories; pre-training the network constructed in the previous step through contrastive learning, nearest neighbor semantic clustering and self-labeling learning in turn; adding, a noise modeling layer on the basis of the constructed deep network, modeling label noise distribution through network self-trust and noisy label information, and performing model training; taking the deep network before the noise modeling layer as a classification model, and classifying taxpayer industries.

### CROSS-REFERENCE TO RELATED APPLICATIONS

The present application is a continuation of International Application No. PCT/CN2021/079378, filed on Mar. 5, 2021, which claims priority to Chinese Application No. 202110201214.5, filed on Feb. 23, 2021, the contents of both of which are incorporated herein by reference in their entireties.

### TECHNICAL FIELD

The present disclosure belongs to the technical field of text classification methods with noisy labels, in particular to a taxpayer industry classification method based on label-noise learning.

### BACKGROUND

It is critical to research the industry classification of enterprise taxpayers, which is the basic work of tax source classification management, and the necessary prerequisite for improving the electronic level of tax file management and implementing information-based tax management, as well as promoting industry modeling and carrying out tax source classification monitoring, early warning, and analysis. The existing classification of ‘taxpayers’ industries is mainly realized manually, which is limited by the professional knowledge and experience of the reporting personnel, and often leads to the wrong classification, which also brings a lot of noise to the taxpayer industry labels of enterprises. The wrong enterprise industry classification will have a series of adverse effects on the country's statistics, taxation, business administration and other work. With the increasing volume and complexity of taxpayer data, it has become an urgent problem to correctly classify taxpayers' industries based on the existing industry classification data with noisy label by means of big data analysis and machine learning. It is of great significance to identify and correct the inconsistency between the existing taxpayer's business scope and industry category, and to provide auxiliary recommendations for taxpayers' industry classification of newly-established enterprises.

At present, there is no relevant research to propose a corresponding solution to the taxpayer's industry classification based on the noisy labeled data. The present disclosure patents related to the taxpayer's industry classification mainly include:

1: A taxpayer industry two-level classification method based on a MIMO recurrent neural network (201910024324.1)

2: Enterprise industry classification method (201711137533.4)

The literature 1 proposed a two-level taxpayer industry classification method based on a MIMO recurrent neural network. A GRU neural network of MIMO is constructed by using 2-dimensional text features and 13-dimensional non-text features as the basic model, and the basic models are grouped and fused according to the mapping relationship between industry categories and industry details, and taxpayers' industries are classified through the fusion model.

The literature 2 proposed an enterprise industry classification method based on semi-supervised learning graph splitting clustering algorithm and gradient lifting decision tree. The semi-supervised graph splitting clustering algorithm is used to extract the key words of the enterprise's main business, and the gradient lifting decision tree is used to train cascade classifiers to realize enterprise industry classification.

The above technical solutions are all based on the premise that the training data industry label is accurate, and the training classification model realizes the taxpayer industry classification. However, in reality, limited by the professional knowledge and experience of the filling personnel, there is a lot of noise in the taxpayer's industry category labeling data in the existing database. If it is directly used for model training, the accuracy of industry classification will drop sharply. Therefore, how to construct a noise-robust taxpayer industry classification model based only on the existing noisy labeled data has become an urgent problem to be solved.

### SUMMARY

The present disclosure aims to provide a taxpayer industry classification method based on label-noise learning. Firstly, the text information encoder extracts text information from taxpayer industry information for text embedding, and performs feature processing on the embedded information; a non-text information encoder extracts non-text information from the taxpayer industry information for encoding; a network construction processor constructs a BERT-CNN (Bidirectional Encoder Representations with Convolutional Neural Network) deep network structure that meets the taxpayer industry classification problem, and determines the number of layers of the network, and the number of neurons and the dimensionality of input and output in each layer according to the feature information and the number of target categories processed in the previous step; a network pre-training processor pre-trains the network constructed in the previous step through contrastive learning, nearest neighbor semantic clustering and self-labeling learning in turn; a robust training processor adds a noise modeling layer on the basis of the constructed deep network, modeling label noise distribution through network self-trust and noisy label information, and performs model training based on the noisy labeled data; a classifier takes the deep network before the noise modeling layer as the classification model, and classifying taxpayer industries based on the model.

In order to achieve the above purpose, the present disclosure adopts the following technical solution:

A taxpayer industry classification method based on label-noise learning includes:

Used for checking noise data, comprising the following steps:

Extracting, by a text information encoder, text information to be mined from taxpayer industry information for text embedding, and performing feature processing on the embedded information.

Extracting, by a non-text information encoder, non-text information from the taxpayer industry information for encoding.

Constructing, by a network construction processor, a BERT-CNN deep network structure that meets a taxpayer industry classification problem, and determining the number of layers of the network, and the number of neurons and the dimensionality of input and output in each layer according to the feature information and the number of target categories processed in the previous step.

Pre-training, by a network pre-training processor, the network constructed in the previous step through contrastive learning, nearest neighbor semantic clustering and self-labeling learning in turn.

Adding, by a robust training processor, a noise modeling layer on the basis of the constructed deep network, modeling label noise distribution through network self-trust and noisy label information, and performing model training based on the noisy labeled data.

Taking, by a classifier, the deep network before the noise modeling layer as a classification model, and classifying taxpayer industries based on the model.

Compared with the prior art, the present disclosure has the following beneficial effects:

The taxpayer industry classification method based on label-noise learning provided by the present disclosure makes full use of the existing taxpayer enterprise registration information, improves the existing classification method, and only builds a noise robust taxpayer industry classification model based on the existing noisy labeled data without additional labeling. Compared with the prior art, the present disclosure has the following advantages:

(1) The present disclosure directly uses the noise data in the existing enterprise registration information to learn the classification model, which is different from the prior art that additional accurately labeled data is usually needed. The present disclosure directly uses the noisy label in the enterprise registration information as the sample label for model training, which saves the data labeling cost.

(2) The present disclosure mines features and the relationship between features by means of contrastive learning, nearest neighbor semantic clustering and self-label learning, and makes full use of the feature similarity between samples of the same category to mine feature information. Different from the prior art method of directly using original features to learn, the present disclosure can avoid the interference of shallow features, mine more information of deep features, and improve the classification accuracy.

(3) The present disclosure provides a noise modeling method, in which a clustering noise modeling layer is constructed based on similar features mined in the previous step, and noisy label information is added into the clustering network through the clustering noise modeling layer, thus improving the clustering accuracy; subsequently, a classification noise modeling layer and a classification permutation matrix layer are constructed based on the clustering results, and the classification model is trained based on the constructed classification noise modeling layer and classification permutation matrix layer, which effectively reduces the adverse effects of noise on the classification network training, ensures the noise robustness of the taxpayer classification network, and improves the classification accuracy with noisy labeled data.

### BRIEF DESCRIPTION OF DRAWINGS

FIG. 1 is the flow chart of an overall framework;

FIG. 2 is the flow chart of taxpayer text information processing;

FIG. 3 is the flow chart of taxpayer non-text information processing;

FIG. 4 is the flow chart of the construction of a taxpayer BERT-CNN classification network;

FIG. 5 is the flow chart of BERT-CNN network pre-training based on nearest neighbor semantic clustering;

FIG. 6 is the flow chart of BERT-CNN network training based on label noise distribution modeling;

FIG. 7 shows the flow chart of taxpayer industry classification;

FIG. 8 is a schematic diagram of a clustering noise modeling network;

FIG. 9 is a schematic diagram of a classification noise learning network.

### DESCRIPTION OF EMBODIMENTS

The present disclosure will be further described in detail with reference to the following drawings:

### Embodiments

The information of taxpayers registered from 2017 to 2019 in the national tax of a certain area is selected, including 97 industry categories. With reference to the following drawings, the present disclosure will be further described in detail in combination with experimental cases and specific embodiments. All technologies realized based on the content of this application belong to the scope of this application.

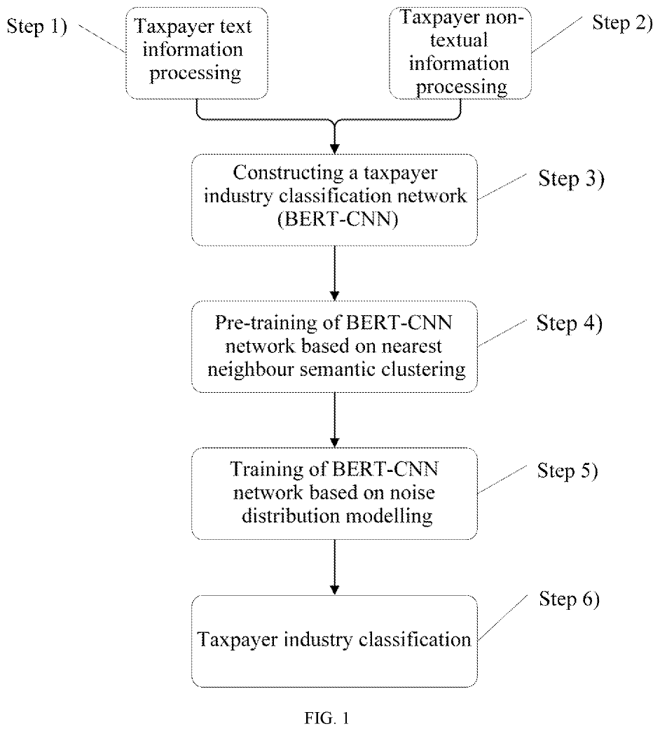

As shown in FIG. 1, in the specific implementation of the present disclosure, the taxpayer industry classification based on label-noise learning includes the following steps:

Step 1. Taxpayer Text Information Processing

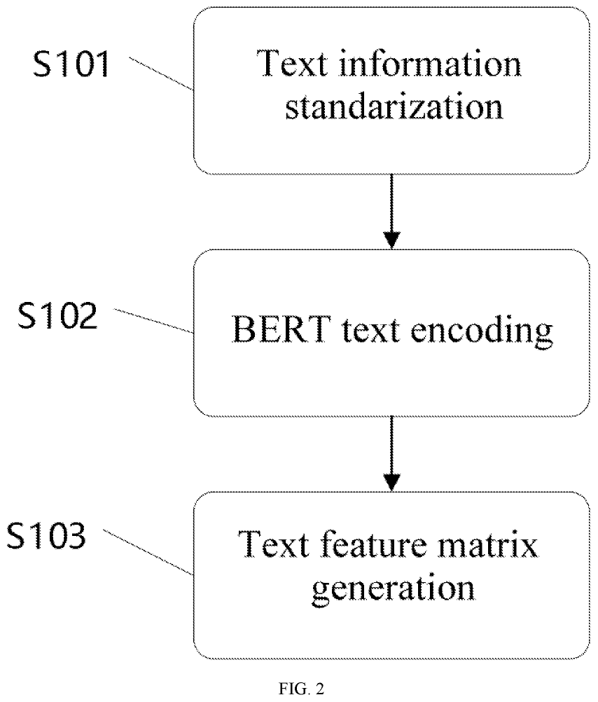

A lot of useful information in the taxpayer information registration form is stored in the database in the form of string text. Five columns {taxpayer's name, main business, part-time business, mode of operation, business scope} are extracted from the registered taxpayer information and registered taxpayer information expansion table as text features. The implementation process of text feature processing by the information encoder is shown in FIG. 2, which specifically includes the following steps:

S101. Text Information Standardization

The required taxpayer text information is screened from the taxpayer registration information table, and the special symbols, numbers and quantifiers in the text information are deleted;

S102. BERT Text Encoding

Text feature generation mainly includes the following steps: adding clause marks before and after the text information, processing control characters other than blank characters, replacement characters and blank characters in the text, dividing sentences by words and removing spaces and non-Chinese characters, and encoding the text information by a BERT pre-training model;

S103. Text Feature Matrix Generation

The embedded vectors after word encoding are spliced into a text feature matrix.

In this embodiment, the taxpayer's name is “ [symbol] [symbol] VR [symbol] [symbol] ”. After step 1, the special symbol a is deleted (S101 in FIG. 2). Then, clause marks are added before and after the text, and after processing non-Chinese characters, AR is deleted, and it is divided into { [symbol] [symbol] [symbol] } according to the characters. The encoding length is selected to be 768 dimensions, and the characters are encoded by a BERT pre-training model (S102 in FIG. 2). After splicing the encoded vectors, a 17×768-dimensional feature matrix is obtained (S103 in FIG. 2).

Step 2. Taxpayer Non-Text Information Processing

Besides text information, the taxpayer registration information database also includes some non-text information, which has more intuitive features. This non-text information is also of great value for taxpayer industry classification, clustering and anomaly detection.

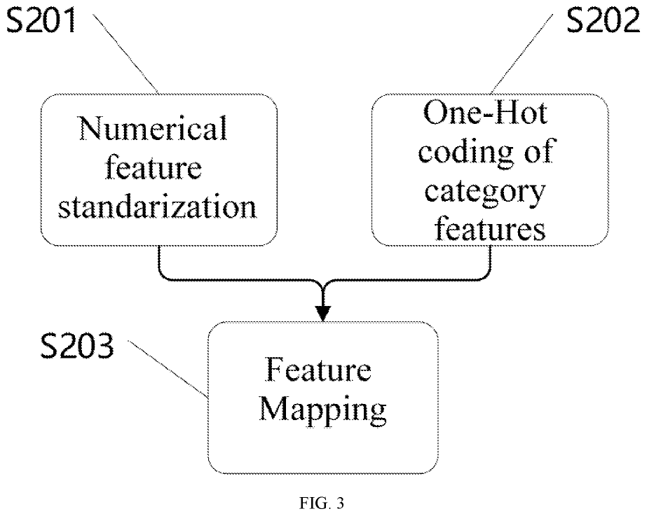

As shown in FIG. 3, the detailed processing steps of non-text attributes by the non-text information encoder in this embodiment include:

S201. Numerical Feature Standardization

The information of registered taxpayers and the expanded information table of registered taxpayers in the taxpayer industry information database are queried, nine columns {registered capital, total investment, number of employees, number of foreigners, number of partners, fixed number, proportion of natural person investment, proportion of foreign investment and proportion of state-owned investment} are selected as numerical features, and z-score processing is carried out on the above nine columns.

In this embodiment, firstly, the sample means μ₁, μ₂, . . . , μ₉ and sample variance σ₁, σ₂, . . . , σ₉ of the above nine columns of features are calculated, Xᵢ is denoted as the value of the i^{th} numerical feature of the sample X, and then the features in the nine columns are mapped by the z-score formula

$${X}_{i}^{*} = \frac{{X}_{i} - {μ}_{i}}{{σ}_{i}} ,$$

(i=1, 2, . . . , 9) to realize the standardization of numerical features (S201 in FIG. 3).

S202. One-Hot Encoding of Categorical Features

The information of registered taxpayers and the expanded information table of registered taxpayers in the taxpayer industry information database are queried, seven columns {registration type, head office mark, whether it is a national and local tax condominium, license category code, industry detail code, whether it is engaged in industries restricted or prohibited by the state, and electronic invoice enterprise mark} are selected as categorical features, and one-hot encoding processing is carried out on the above seven columns.

In this embodiment, the feature of the head office mark is taken as an example, firstly, the value range of the head office mark is calculated. After calculation, there are three types of head office mark values {head office, non-head office and branch office}, so a 3-bit register is set to encode them; then {head office, non-head office and branch office} are mapped into three register codes of {001, 010, 100} respectively; finally, according to the mapping rule, all the features of the column of the head office mark column are encoded (S202 in FIG. 3).

S203. Feature Mapping

After the non-text features and text features are processed in steps S201 and S202, feature vectors are obtained, and these feature vectors are mapped and spliced by a linear layer to obtain a complete numerical feature matrix.

Specifically, in this embodiment, firstly, the normalized numerical features are mapped into 768-dimensional feature vectors by constructing a 1×768-dimensional linear layer; then, the maximum dimensions of status registers with different types of features are compared, and the maximum dimension is 264 dimensions after comparison; the codes with less than 264 dimensions are supplemented with 0 to 264 dimensions; the a 264×768-dimensional linear layer is constructed finally to map the categorical feature codes to 768 dimensions, and the vectors mapped by the two linear layers are spliced to obtain a non-text feature vector matrix (S203 in FIG. 3).

Step 3: Constructing a Taxpayer Industry Classification Network (BERT-CNN)

A BERT-CNN network has four layers of network structure, and the input layer is divided into a text feature encoding part and a non-text feature mapping part; the second layer is a convolutional neural network layer, which is used for feature mining and extraction; the third layer implements max-pooling for the output of the second layer; the output layer is a fully connected layer with softmax, and the network is built by the network construction processor.

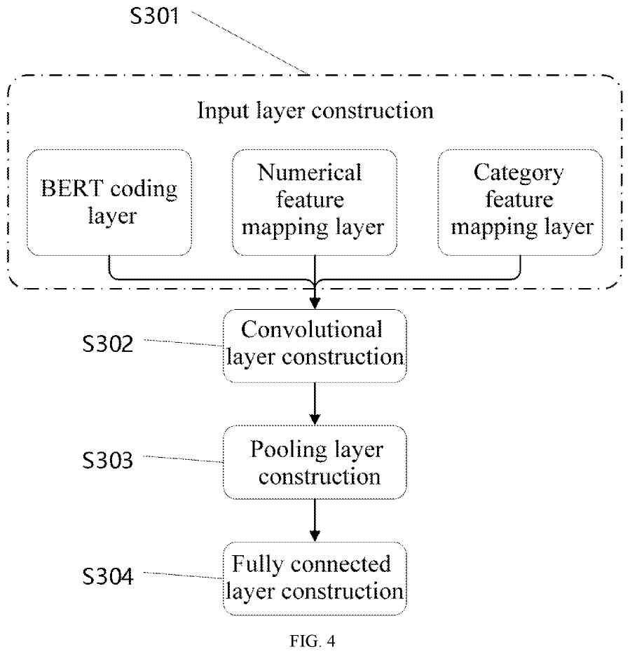

In this embodiment, firstly, a 768-dimensional BERT encoding part, a 1×768-dimensional numerical feature mapping linear layer and a 264×768-dimensional categorical feature mapping linear layer are used as the first layer; first of all, for the BERT encoding part, in this embodiment, there are five features of {taxpayer name, main business, part-time business, mode of operation and business scope}; the dimensions of the feature matrix re set to be {20×768, 20×768, 20×768, 10×768, 100×768}; specifically, take the taxpayer's name as an example, the output is set as a 20×768-dimensional matrix; for those less than 20 words after segmentation, zero is added for alignment, and those more than 20 words are intercepted; the numerical feature mapping linear layer outputs a 9×768-dimensional matrix, the categorical feature mapping linear layer outputs a 7×768-dimensional matrix, and the three matrices are spliced into a 36×768-dimensional matrix as the output of this layer (FIG. 4 S301); one-dimensional convolution kernels of 2×768, 3×768, 4×768, 5×768 and 6×768 are respectively constructed by the second layer to perform convolution operation on the matrix of the previous layer (FIG. 4 S302); the third layer is a pooling layer, which performs 2-maxpooling on the output of the previous layer, retains the two maximum pieces of information output by each convolution kernel and splices them (S303 in FIG. 4); Finally, a fully connected layer is constructed to map the output of the previous layer to a 97-dimensional vector (S304 in FIG. 4).

Step 4. BERT-CNN Network Pre-Training Based on Nearest Neighbor Semantic Clustering

The BERT-CNN network pre-training based on nearest neighbor semantic clustering is divided into three steps: contrastive learning, nearest neighbor semantic clustering and self-labeling learning. The network pre-training processor firstly mask the samples to construct similar samples according to the idea that similar samples have similar feature representations, and implements contrastive learning by minimizing the distance between the network feature representations of the original samples and the control samples; secondly, the nearest neighbors of multiple samples are selected according to the network feature representation, and the nearest neighbor semantic clustering is carried out by minimizing the distance between the network feature representations of the nearest neighbors; finally, the samples with high confidence are selected as prototype samples, and self-labeling learning is carried out based on cluster labels of prototype samples.

In this embodiment, the data set is divided into a training set, a verification set and a test set according to the proportion of 8:1:1. The training set is used for network training, the verification set is used to select the training model, and the test set is used to test the model effect. The specific training process is as follows: firstly, the feature matrix of the feature of the sample X encoded by the input layer is set to be S_{X}, and it can be known that each line vector of S_{X} corresponds to a character in the text features or a feature in the non-text features, that is, each line vector corresponds to an original feature; the number h ∈ {1, 2, . . . , 10} is randomly selected, and the line h of S_{X} is randomly set to be 0 vector as a control sample, and the matrix after mask is denoted as ψ(S_{X}); the network parameter of the first three layers is denoted as θ, and the output of the third layer as the vectors f_{θ}(S_{X}) and f_{θ}(ψ(S_{X})); back propagation is carried out by using

$${min}_{θ} d ( {f}_{θ} ( {S}_{X} ) , {f}_{θ} ( ψ ( {S}_{X} ) ) )$$

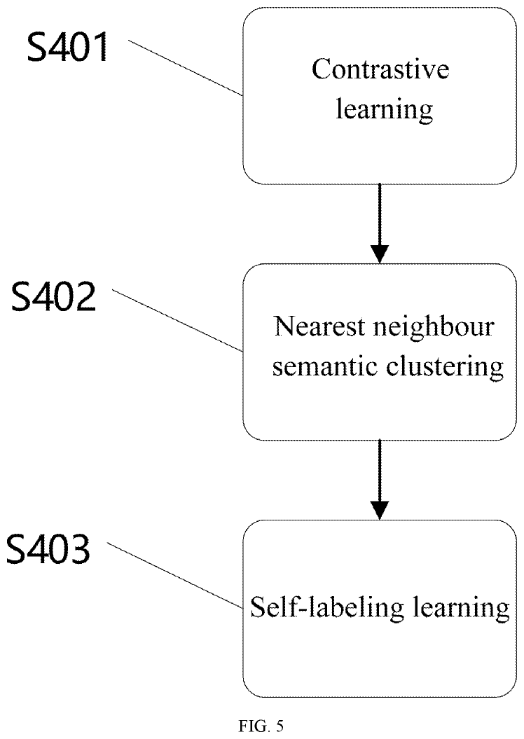

as the training objective to realize contrastive learning, and finally the 20 nearest neighbors of each sample are calculated according to the Euclidean distance between the output vectors of the third layer for subsequent training (FIG. 5 S401); secondly, according to the nearest neighbors selected by contrastive learning, the sample set is denoted as [symbol] , X is a sample in [symbol] , the nearest neighbor set of X is [symbol] _{X}, η is a network parameter, g_{η}(X) is the vector output after the sample X is mapped through the network, and g_{η}^{c}(X) is the probability of the sample X being classified into the first class through the network estimation, and back propagation is carried out using

$${min}_{η} ( - \frac{1}{\vert 𝒟 \vert} {\sum }_{X ∈ 𝒟} {\sum }_{K ∈ {𝒩}_{X}} log 〈 {g}_{η} ( X ) , {g}_{η} ( K ) 〉 + λ {\sum }_{c ∈ 𝒞} {g}_{η}^{′ c} log {g}_{η}^{′ c} )$$

as the optimization objective to realize nearest neighbor semantic clustering (FIG. 5 S402); finally, the samples with a probability of being assigned to this cluster higher than 0.9 in each cluster after clustering are selected as prototype samples, and the prototype sample set is denoted as [symbol] ′, | [symbol] ′| is the number of elements in [symbol] ′, Xᵢ is a sample in [symbol] ′, y′ᵢ is the cluster to which Xᵢ belongs, y′ᵢ is an indication vector generated after one-hot encoding of y′ᵢ, i=1, . . . , | [symbol] ′|, back propagation is carried out using

$${min}_{η} ( - \frac{1}{\vert {𝒟}^{′} \vert} ) {\sum }_{{X}_{i} ∈ {𝒟}^{′}} {y}_{i}^{′} log 〈 {g}_{η} ( {X}_{i} ) 〉$$

as the optimization objective to realize self-labeling learning, and a clustering network is obtained (S403 in FIG. 5).

Step 5. BERT-CNN Network Training Based on Label Noise Distribution Modeling

The BERT-CNN network pre-training based on label noise distribution modeling includes constructing a cluster noise modeling layer, pre-training the cluster noise modeling layer, training the clustering network based on the cluster noise modeling layer, generating a classification permutation matrix, generating a classification noise modeling matrix, transferring the clustering network to a classification network, constructing the classification noise modeling layer and training the classification network.

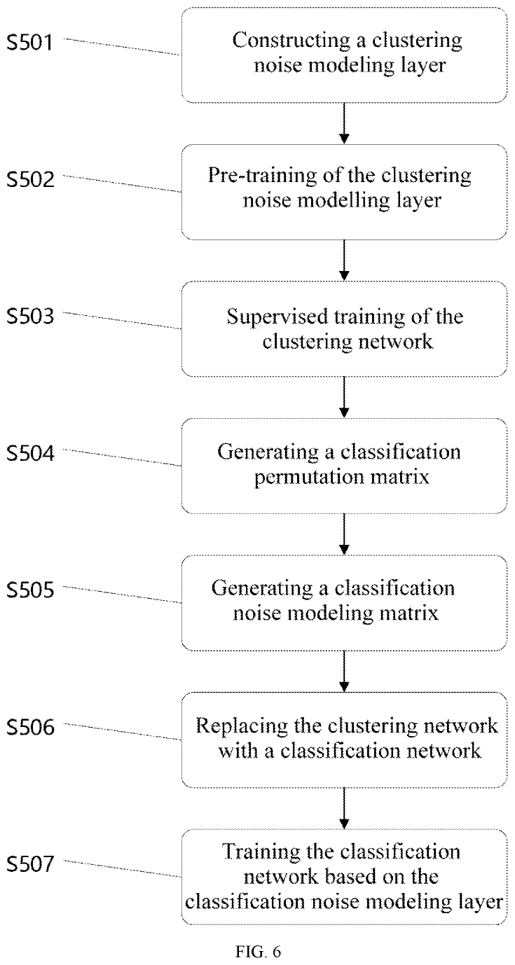

In this embodiment, a robust training processor constructs a transfer matrix T of 97×97, which will be added as an additional layer to the current clustering network (S501 in FIG. 6); a parameter η of the current clustering network is fixed, the output of a noise sample pair (X, \tilde{Y}) in the clustering network is denoted as g(X), and the output after passing through the noise modeling layer is q(X)=T^{T} g(X), q(X) and \tilde{Y} are subjected to cross entropy loss and back propagation to update T (S502 in FIG. 6); the clustering network is trained on the basis of the existing network and noise modeling layer, the clustering noise modeling layer is fine-tuned, the network performance is further improved by adding noisy label information; back propagation is carried out using

$${min}_{η , T} ( α ( - \frac{1}{\vert 𝒟 \vert} {\sum }_{X ∈ 𝒟} {\sum }_{K ∈ {𝒩}_{X}} log 〈 {g}_{η} ( X ) , {g}_{η} ( K ) 〉 + λ {\sum }_{c ∈ 𝒞} {g}_{η}^{′ c} log {g}_{η}^{′ c} ) + ( 1 - α ) CE ( {T}^{⊤} {g}_{η} ( X ) , \tilde{Y} ) )$$

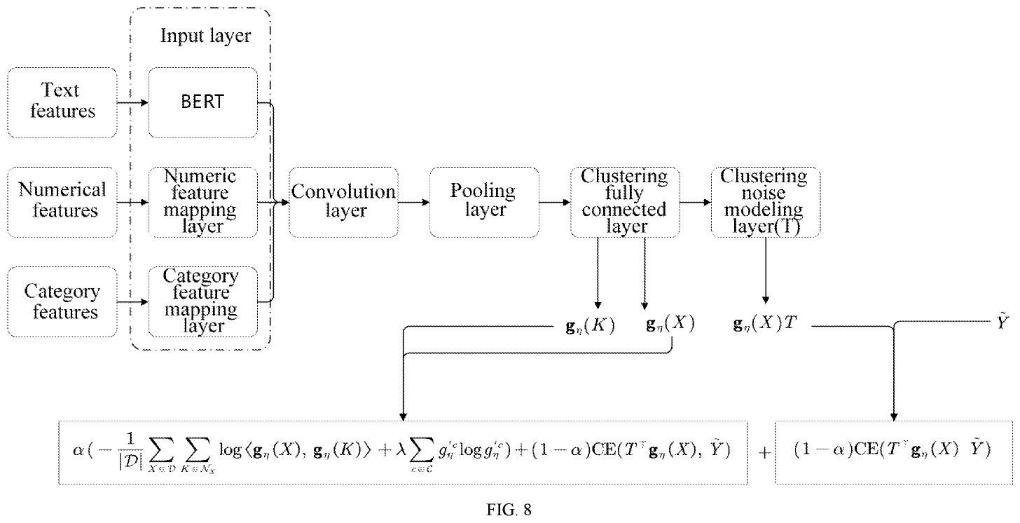

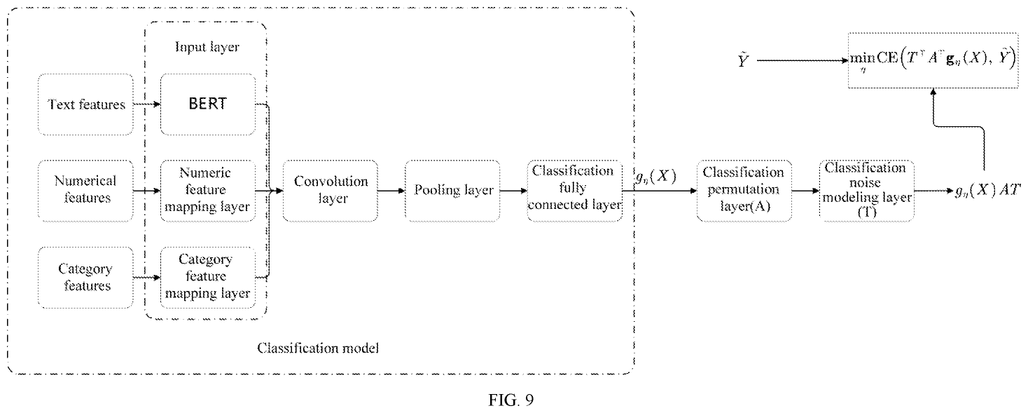

as the optimization objective to train the network (S503 in FIG. 6); the training network structure is shown in FIG. 8; a 97×97-dimensional permutation matrix is constructed by convex optimization (S504 in FIG. 6); the sample is divided into 97 clusters by the clustering network, and the number of noisy labels is calculated on each cluster to construct a noise modeling matrix T (S505 in FIG. 6); the weight and offset of the network output layer are replaced based on the permutation matrix, and the clustering network is replaced with the classification network (S506 in FIG. 6); as shown in FIG. 9, two noise modeling layers are constructed, the first modeling layer is the classification permutation matrix A, and the second modeling layer is the noise modeling matrix T,

$${min}_{η} CE ( {T}^{⊤} {A}^{⊤} {h}_{η} ( X ) , \tilde{Y} )$$

is used as the training objective of the classification network, and the final classification network is obtained by back propagation (S507 in FIG. 6).

Step 6. Taxpayer Industry Classification

As shown in FIG. 9, the classifier classifies taxpayers' industries based on the first four layers of the trained network as the final classification network, which specifically includes two steps: predicting the probability of taxpayers' industries and classifying taxpayers' industries.

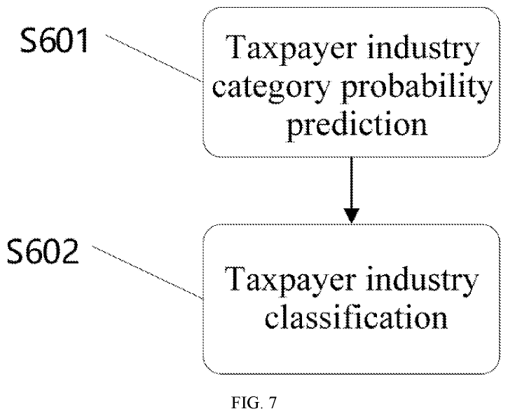

Specifically, in this embodiment, the test set sample X is input into the network to obtain a 97-dimensional classification probability vector g_{η}(X) (S601 in FIG. 7), and the index of the maximum value from the vector is taken as the classification result of X (S602 in FIG. 7).

The steps of the method or algorithm described with reference to the disclosure of the embodiments of the present disclosure can be implemented in hardware or by a processor executing software instructions. Software instructions can be composed of corresponding software modules, which can be stored in a Random Access Memory (RAM), a flash memory, a Read Only Memory (ROM), a Erasable Programmable ROM (EPROM), an electrically erasable programmable read-only memory (EEPROM), a register, a hard disk, a removable hard disk, a CD-ROM or any other form of storage medium known in the art. An exemplary storage medium is coupled to the processor so that the processor can read information from and write information to the storage medium. Of course, the storage medium can also be an integral part of the processor. The processor and storage medium may be located in ASIC. In addition, the ASIC may be located in a node device (such as the above processing node). Of course, the processor and the storage medium can also exist in the node device as discrete components.

The present disclosure can be a system, a method and/or a computer program product. The computer program product may include a computer readable storage medium loaded with computer readable program instructions for causing a processor to implement aspects of the present disclosure. The computer-readable storage medium can be a tangible device that can hold and store instructions used by the instruction execution device. The computer-readable storage medium can be, for example, but not limited to, an electrical storage device, a magnetic storage device, an optical storage device, an electromagnetic storage device, a semiconductor storage device or any suitable combination of the above. More specific examples (non-exhaustive list) of computer-readable storage media include portable computer disks, hard disks, random access memories (RAM), read-only memories (ROM), erasable programmable read-only memories (EPROM or flash memory), static random access memories (SRAM), portable compact disk read-only memories (CD-ROM), digital versatile disks (DVD), memory sticks, floppy disks, and floppy disks. The computer-readable storage medium used here is not interpreted as instantaneous signals themselves, such as radio waves or other freely propagating electromagnetic waves, electromagnetic waves propagating through waveguides or other transmission media (e.g., light pulses through optical fiber cables), or electrical signals transmitted through electric wires. The computer-readable program instructions described here can be downloaded from computer-readable storage media to various computing/processing devices, or downloaded to external computers or external storage devices through networks, such as the Internet, local area networks, wide area networks and/or wireless networks. The network may include copper transmission cable, optical fiber transmission, wireless transmission, router, firewall, switch, gateway computer and/or edge server. The network adapter card or network interface in each computing/processing device receives computer readable program instructions from the network and forwards the computer readable program instructions for storage in the computer readable storage media in each computing/processing device.

What is claimed is:

1. A taxpayer industry classification method based on label-noise learning, which is used for checking noise data, comprising the following steps:
extracting, by a text information encoder, text information to be mined from taxpayer industry information for text embedding, and performing feature processing on embedded information;
extracting, by a non-text information encoder, non-text information from the taxpayer industry information for encoding;
constructing, by a network construction processor, a BERT-CNN deep network structure that meets a taxpayer industry classification problem, and determining a number of layers of the network, a number of neurons in each layer and dimensionality of input and output according to the feature information and a number of target categories processed in a previous step;
pre-training, by a network pre-training processor, the network constructed in a previous step through contrastive learning, nearest neighbor semantic clustering and self-labeling learning in turn;
adding, by a robust training processor, a noise modeling layer on the basis of the constructed deep network, modeling label noise distribution through network self-trust and noisy label information, and performing model training based on the noisy labeled data;
taking, by a classifier, the deep network before the noise modeling layer as a classification model, and classifying taxpayer industries based on the classification model.

2. The taxpayer industry classification method based on label-noise learning according to claim 1, comprising the following steps:
step 1): taxpayer text information processing:
screening, by the text information encoder, required taxpayer text information from taxpayer registration information, selecting a Chinese BERT pre-training model based on a RoBERTa training method as an encoding model, encoding the text information to obtain an embedded high-dimensional text feature vector, and taking the Chinese BERT pre-training model as part of a first layer of a BERT-CNN model to participate in model training;
step 2): taxpayer non-text information processing:
screening, by the non-text information encoder, the required taxpayer non-text information from the taxpayer registration information, and dividing, according to whether a value of non-text information is continuous, the taxpayer non-text information into two categories: continuous numerical features and discrete categorical features; normalizing the numerical features by z-score, and encoding the categorical features by one-hot encoding;
step 3): construction of a BERT-CNN taxpayer industry classification network:
constructing, by the network construction processor, a BERT-CNN network with four layers, namely an input layer, a convolution layer, a pooling layer and a fully connected layer, as a classification network, and setting the number of neurons in each layer according to selected taxpayer information dimension and required output categories;
step 4): BERT-CNN network pre-training based on nearest neighbor semantic clustering:
performing, by the network pre-training processor, contrastive learning based on a contrastive learning method, embedding a feature of a sample into the feature vector of a specific dimension according to a learned network, and finding K nearest neighbors thereof according to a Euclidean distance of the feature vector;
carrying out the nearest neighbor semantic clustering on the learned network based on the features of the sample and the K neighbors thereof to further train the network; performing self-label learning according to a clustering result of a current network on the basis of a network constructed in the previous step to obtain a final pre-trained network;
step 5): BERT-CNN network training based on label noise distribution modeling:
adding, by a robust training processor, a noise modeling layer on the basis of the pre-trained network, using the noise modeling layer to fit noise to realize noise modeling; minimizing a nearest neighbor distance based on the nearest neighbor semantic clustering before the modeling layer, and minimizing a cross entropy loss after the modeling layer fit the noise, so that the network is capable of obtaining the information of both the neighbors of a training sample and sample labels at the same time; reducing the impact of the noise based on an information class of the neighbors of the sample, and improving the classification accuracy based on the label information processed by the noise modeling layer;
step 6): taxpayer industry classification:
taking the BERT-CNN network that has been trained in the above five steps by the classifier as a classification network to classify corporate taxpayers.

3. The taxpayer industry classification method based on label-noise learning according to claim 2, wherein in step 1), the taxpayer text information processing by the text information encoder specifically comprises the following steps:
step 101: text information standardization:
screening, by the text information encoder, the required taxpayer text information from the taxpayer registration information, and deleting special symbols, numbers and quantifiers from the text information;
step 102: BERT text encoding:
dividing, at the same time, by a BERT, Chinese text into words with context information according to a context-based sub-word strategy, and converting the expressions of different words into word vectors without being restricted by dictionaries;
step 103: text feature generation:
embedding, by the text information encoder, a word vector by using a 24-layer Chinese BERT model trained based on the RoBERTa pre-training method, so that the text information encoder is capable of fully obtaining context information during word embedding, thereby solving a problem that polysemy often occurs in a description of business name, business scope, place name and personal name in taxpayer registration information;
wherein the Chinese RoBERTa pre-training method is a large BERT model pre-training method which is improved on the BERT pre-training method and realized based on Transformer bidirectional encoding representation, and the BERT model trained by the method performs word segmentation and word embedding on text features, which comprises the following steps:
step a: adding a [CLS] sign before the text information and a [SEP] sign after the text information;
step b: removing control characters and replacement characters except blank characters in the text, and converting the blank characters into spaces;
step c: segmenting sentences based on characters, and removing spaces and non-Chinese characters; and
step d: encoding the text information through the pre-training model, and splicing embedded vectors after word encoding into a feature matrix.

4. The taxpayer industry classification method based on label-noise learning according to claim 3, wherein in step 2), the non-text information encoder maps the numerical features through z-score standardization, so that a mean value is 0 and a standard deviation is 1, wherein the z-score method comprises the following steps:
step I: respectively calculating a sample mean μ of each numerical feature as an estimation expected for the feature;
step II: respectively calculating a sample standard deviation a of each numerical feature as an estimation of a standard deviation of the feature;
step III: standardizing each numerical feature according to a z-score formula:
$${X}_{cat}^{*} = \frac{{X}_{cat} - μ}{σ}$$
where X_{cat} represents a numeric feature of the sample, and X*_{cat} represents a result of X_{cat} after z-score standardized mapping; and
wherein the step of encoding the categorical features by one-hot encoding comprises the following steps:
step i: using a status register of N bits to represent a categorical feature with N possible values;
step ii: indicating, by each bit of the status register, whether a feature value is valid or not; if valid, the valid value is 1, and if not, the invalid value is 0, wherein it is stipulated that only one bit of each register is valid;
step iii: encoding each feature according to the provisions of step ii to obtain a one-hot vector for subsequent training;
wherein the non-text information encoder maps the processed feature vectors to a same dimension as a text feature vector through a linear layer, and splices the mapped vectors to obtain a non-text feature matrix.

5. The taxpayer industry classification method based on label-noise learning according to claim 4, wherein in step 3), the network construction processor constructs a BERT-CNN network; the BERT-CNN network has four layers of network structure, and the input layer is divided into a text feature encoding part and a non-text feature mapping part; the second layer is a convolutional neural network layer, which is used for feature mining and extraction; the third layer carries out max-pooling for the output of the second layer; the output layer is a fully connected layer, and the output of the fully connected layer is subjected to softmax to obtain a final classification result; the construction steps of the BERT-CNN network are as follows:
step 301: input layer construction:
constructing the text feature encoding part of the input layer,
wherein the network processor respectively selects t positive integers kᵢ, i=1, 2, . . . , t for t text features, and sets the feature matrix dimensions of the t text features to be kᵢ×m; assuming that a i^{th} text after processing has a total of hᵢ characters, and the BERT word encoding dimension is set to be m, which is input into the BERT encoding layer for encoding according to the encoding method proposed herein to obtain a sandwich matrix of hᵢ×m dimensions; the feature matrix output by a BERT encoding part of the first layer is obtained by aligning the sandwich matrix to the kᵢ×m dimensions; and
wherein the specific alignment method is as follows: if hᵢ<kᵢ, 0 vectors are added to the upper and lower positions of the sandwich matrix through padding operation to align to the kᵢ×m dimension; if hᵢ>kᵢ, the vector whose first dimension index of the sandwich matrix is greater than kᵢ, so as to align to the kᵢ×m dimension; and if hᵢ=kᵢ, the sandwich matrix is directly used as the feature matrix output by the BERT encoding part of the first layer;
constructing the non-text feature mapping part of the input layer,
wherein the network construction processor constructs two parallel linear layers:
one linear layer of 1×m is used to deal with the numerical features, and through this linear layer, u numerical features are mapped into a feature matrix of u×m dimensions using the linear layer;
the other linear layer is used to process the categorical features; the dimension of the embedded one-hot vector of v categorical features is set to be j_{c}, c=1, 2, . . . , v, the vector is aligned to a
$${j}_{m a x} = {max}_{c} {j}_{c}$$
dimension by adding 0 at the end of the vector, and v categorical features are mapped to the v×m dimensions through the linear layer of jₘₐₓ×m dimensions; and
wherein the network construction processor splices the output of the BERT encoding part with the output of the two parallel linear layers to obtain a matrix of (Σᵢ^{y}kᵢ+u+v)×m as the output of the first layer;
step 302: constructing the convolution layer,
wherein the convolution layer comprises one one-dimensional convolution kernel with dimensions of 2×m, 3×m, 4×m, 5×m, 6×m, respectively;
step 303: constructing the pooling layer,
wherein the pooling method of the pooling layer is p-max-pooling, in which the maximum p pieces of information of the output of each convolution kernel are retained and the outputs are connected;
step 304: constructing the fully connected layer,
wherein the network construction processor constructs a linear layer to map the output of step 303 to a l-dimension vector, where l is the number of target categories, and the vector is subjected to softmax operation.

6. The taxpayer industry classification method based on label-noise learning according to claim 5, wherein in step 4), the pre-training of the BERT-CNN network comprises the following steps:
step 401: contrastive learning,
wherein the network pre-training processor masks the samples to construct similar samples according to the idea that similar samples have similar feature representations, so that the original samples and mask results thereof have similar feature representations, thereby improving the robustness and feature mining ability of the network; wherein the feature matrix of the feature of a sample X encoded by the input layer is set to be S_{X}, and it is known from the construction method that each line vector of S_{X} corresponds to a character in the text feature or a feature in the non-text feature, that is, each line vector corresponds to an original feature; select a positive integer maskₘₐₓ is selected, h={1, 2, . . . , maskₘₐₓ} is randomly selected, and h lines of S_{X} are randomly masked to make it be a 0 vector as a control sample, and the matrix after mask is denoted as ψ(S_{X});
wherein the network pre-training processor inputs S_{X} and ψ(S_{X}) into subsequent networks, respectively, a network parameter of the first three layers is denoted as θ, f(X) is a mapping of X by the first three layers, the output of the third layer is vectors f_{θ}(S_{X}) and f_{σ}(ψ(S_{X})), and the network is updated by minimizing the distance of f(S_{X}) and f(ψ(S_{X})), then a training objective is:
$${min}_{θ} d ( {f}_{θ} ( {S}_{X} ) , {f}_{θ} ( ψ ( {S}_{X} ) ) ) ;$$
and
wherein the network pre-training processor selects a positive integer n, carries out back propagation to update the network parameter of the first three layers according to the training objective to complete the first step of pre-training, and calculates the nearest neighbors of each sample n for subsequent training according to the Euclidean distance between the output vectors of the third layer;
step 402: nearest semantic neighbor clustering,
wherein according to the nearest neighbors selected in step 401, since the samples with similar feature vectors usually come from the same industry category, the network pre-training processor reduces the distance between the feature vectors of the nearest neighbors to improve the classification ability of the network, and at the same time ensures the balance of each category by a regular term to prevent category disappearing; and
wherein the network pre-training processor first initializes the first three layers of the network to the network trained in step 401; it is assumed that enterprises need to be divided into C classes, and a sample set is denoted as [symbol] , X is a sample in [symbol] , and a set of the nearest neighbors of X is [symbol] _{X}, η is a network parameter, g_{η}(X) is the vector output by the sample X after network mapping, and g_{η}^{c}(X) is the probability that the sample X will be divided into a c^{th} class by network estimation, c ∈ [symbol] and C={1, . . . , [symbol] }, then an optimization objective is:
$${min}_{η} ( - \frac{1}{\vert 𝒟 \vert} {\sum }_{X ∈ 𝒟} {\sum }_{K ∈ {𝒩}_{X}} log 〈 {g}_{η} ( X ) , {g}_{η} ( K ) 〉 + λ {\sum }_{c ∈ 𝒞} {g}_{η}^{′ c} log {g}_{η}^{′ c} )$$
where <•> is a dot product operation, and λ is a super parameter of controlling the weights of two parts of the optimization objective,
$${g}_{η}^{′ c} = \frac{1}{\vert 𝒟 \vert} {\sum }_{X ∈ 𝒟} {g}_{η}^{c} ( X ) ;$$
according to the optimization objective, back propagation is carried out to update the whole network, and the second step of pre-training is completed;
step 403: self-label learning,
wherein a preliminary pre-trained clustering network is obtained according to the first two steps; based on the network trained in step 402, the network pre-training processor calculates the clustering results of all samples and the probability of the samples being classified into this category, takes the sample with a higher probability as a prototype, and uses the clustering result thereof as a label to tune the network to improve the performance of the network;
wherein a threshold value τ is selected, a sample with a probability of being assigned to a cluster higher than τ on each cluster after clustering is selected as a prototype sample, and the network is directly trained based on the cross entropy loss; the clustering result of the prototype sample is used as the label thereof to train the network; [symbol] ′ is a prototype sample set, | [symbol] ′| is a number of elements in [symbol] ′, Xᵢ is a sample in [symbol] ′, y′ᵢ is the cluster where Xᵢ belongs, and y′ᵢ is an indication vector generated after one-hot encoding, i=1, . . . , | [symbol] ′|, and then the training objective is:
$${min}_{η} ( - \frac{1}{\vert {𝒟}^{′} \vert} ) {\sum }_{{X}_{i} ∈ {𝒟}^{′}} {y}_{i}^{′} log 〈 {g}_{η} ( {X}_{i} ) 〉 ;$$
and back propagation is carried out to update the whole network according to the optimization objective to complete the pre-training of the network, and a clustering network is obtained; and
noisy label modeling and classification network training,
wherein a noisy label in the current taxpayer registration information is denoted as \tilde{Y}, the sample is X, the result of sample clustering is Y′, and a real label of the sample is Y; assuming that X is independent from both \tilde{Y} and Y′, then for any category c ∈ [symbol] :
P(\tilde{Y}=c|X)= [symbol] [symbol] P(\tilde{Y}=c|Y′=i)P(Y′=i|Y=j)P(Y=j|X); and
wherein for any c, i, j, if P(\tilde{Y}=c|Y′=i) and P(Y′=i|Y=j) is obtained, the problem of solving P(Y=j|X) is converted into a solution of P(\tilde{Y}=c|X), so that the noise is filtered out based on \tilde{Y} to learn the information of Y.

7. The taxpayer industry classification method based on label-noise learning according to claim 6, wherein in step 5), the robust training processor models the noise and constructs the noise modeling layer by the following method:
step 501: constructing a clustering noise modeling layer,
wherein the clustering noise modeling layer is a transfer matrix of C×C, which is denoted as T, where T_{i,c}=P(\tilde{Y}=c|Y′=i); and after T is added to the current clustering network as an additional layer, the elements in T are updated as network parameters;
step 502: pre-training of the clustering noise modeling layer,
wherein the robust training processor fixes a parameter 77 of the current clustering network, records the output of a noise sample pair in the clustering network as g(X), and the output after passing through the noise modeling layer is q(X)=T^{T}g(X), q(X) and \tilde{Y} are subjected to cross entropy loss and back propagation to update T, thereby obtaining a pre-trained transfer matrix;
step 503: training the clustering network based on the clustering noise modeling layer,
wherein the robust training processor trains the clustering network on the basis of the existing network and the noise modeling layer, tunes the clustering noise modeling layer, and further improves the performance of the network by adding noisy label information; the optimization objective is:
$${min}_{η , T} ( α ( - \frac{1}{\vert 𝒟 \vert} {\sum }_{X ∈ 𝒟} {\sum }_{K ∈ {𝒩}_{X}} log 〈 {g}_{η} ( X ) , {g}_{η} ( K ) 〉 + λ {\sum }_{c ∈ 𝒞} {g}_{η}^{′ c} log {g}_{η}^{′ c} ) + ( 1 - α ) CE ( {T}^{⊤} g ( X ) , \tilde{Y} ) ) \\ where \\ CE ( {T}^{⊤} {g}_{η} ( X ) , \tilde{Y} ) = \frac{1}{\vert 𝒞 \vert} {\sum }_{X ∈ 𝒟} {\sum }_{c ∈ 𝒞} 1 ( \tilde{Y} = c ) log ( {T}^{⊤} {g}_{η} ( X ) ) ) , \qquad 1 ( \cdot )$$
represents an indication vector, and a is a parameter for adjusting the weights of two parts of the optimization objective;
step 504: generating a classification permutation matrix,
wherein an output result of the current clustering network is a clustering result, and the output category needs to correspond to the classification category; the classification permutation matrix A is a transfer matrix of C×C, A_{j,i}=P(Y′=i|Y=j); the amount of real data in noise data is considered to be significant in the taxpayer industry classification problem, that is, the amount of noise in each category is less than 0.5, so the robust training processor is capable of obtaining the permutation matrix by convex optimization;
wherein the specific steps of convex optimization restriction are as follows:
$$∀ i , j , {A}_{j , i} ∈ \{ 0 , 1 \} \\ ∀ j , {\sum }_{i ∈ 𝒞} {A}_{j , i} = 1 \\ ∀ i , {\sum }_{j ∈ 𝒞} {A}_{j , i} = 1$$
a convex optimization objective is:
$${min}_{A} \frac{1}{\vert 𝒞 \vert} {\sum }_{X ∈ 𝒟} {\sum }_{c ∈ 𝒞} 1 ( \tilde{Y} = c ) log ( Ag ( X ) ) ) ,$$
and
wherein the classification permutation matrix is obtained for subsequent training;
step 505: generating the noise modeling matrix,
wherein the noise modeling matrix is a transfer matrix of C×C, where T_{i,c}=P(\tilde{Y}=c|Y′=i); the samples is divided into C clusters based on the network learned in step 3), and the robust training processor calculate the number of noisy labels in each cluster, so as to obtain a more accurate noise modeling matrix on the whole samples; and
wherein the method of obtaining the matrix is:
$${T}_{i , c} = \frac{count ( \tilde{Y} = c ⋂ g ( X ) = i )}{count ( g ( X ) = i )}$$
where count(•) is a counting function to calculate the number of samples that meet the conditions, and g(X) is the cluster to which X belongs after the calculation of the clustering network;
step 506: transposing the clustering network to the classification network,
wherein W₄ and b₄ are denoted as the weight and offset parameter of the output layer of the network, respectively, and the robust training processor transposes W₄ and b₄ as follows:
W₄:=AW₄
b₄:=Ab₄
at this time, the output result of the network is transposed from the estimation \hat{P}(\tilde{Y}|X) of the cluster to the estimation \hat{P}(Y|X) of the classification result, the network is transposed to the classification network, where the vector of the sample X mapped by the classification network with a parameter η is denoted as h_{η}(X); and
step 507: constructing the noise modeling layer and tuning the classification network,
wherein after the output of the classification network, two layers of matrices are constructed to form the noise modeling layer, the first modeling layer is a classification permutation matrix A, and the second modeling layer is a noise modeling matrix T, and then the training objective of the classification network is:
$${min}_{η} CE ( {T}^{⊤} {A}^{⊤} {h}_{η} ( X ) , \tilde{Y} ) \\ where \\ CE ( {T}^{⊤} {A}^{⊤} {h}_{η} ( X ) , \tilde{Y} ) = \frac{1}{\vert 𝒞 \vert} {\sum }_{c ∈ 𝒞} 1 ( \tilde{Y} = c ) log ( {T}^{⊤} {A}^{⊤} {h}_{η} ( X ) ) ) ;$$
a final classification network is obtained by training the network through the training objective.

8. The taxpayer industry classification method based on label-noise learning according to claim 7, wherein in step 6), the classifier classifies the taxpayer industries through the BERT-CNN network, and the method is as follows:
step 601: predicting a category probability of a taxpayer industry,
wherein for taxpayer samples, the classifier inputs the information thereof into the network after processing in step 1) and step 2), and a prediction vector h_{η}(X) is obtained through network prediction, where h_{η}ⁱ(X)(i=1, 2, . . . , C) is an i^{th} component of h_{η}(X), which represents a probability of P(Y=i|X) that X is classified into the i^{th} category; and
step 602: taxpayer industry classification,
wherein the classifier calculates
$$r = {max}_{i} {h}_{η}^{i} ( x ) ,$$
and then the category r is the industry category to which the taxpayer sample X belongs.
